(19) United States
(12) Patent Application Publication
(10) Pub. No.: US 2026/0104667 A1
(43) Pub. Date: Apr. 16, 2026

(54) IMAGE FORMING APPARATUS

(71) Applicant: KYOCERA Document Solutions Inc., Osaka (JP)

(72) Inventor: Akira ISHII, Osaka (JP)

(73) Assignee: KYOCERA Document Solutions Inc., Osaka (JP)

(21) Appl. No.: 19/348,887

(22) Filed: Oct. 3, 2025

(30) Foreign Application Priority Data
Oct. 15, 2024 (JP) 2024-179904

(51) Int. Cl. G03G 15/00; B65H 5/06

(52) U.S. Cl. CPC G03G 15/6511; B65H 5/062; B65H 2404/143; B65H 2404/693; B65H 2701/1131; B65H 2801/15

(57) ABSTRACT

An image forming apparatus includes an image forming portion, a sheet feeding portion, a discharge portion, a sheet conveyance passage, a branch conveyance passage, a conveyance guide, and a pair of assist rollers. The conveyance guide forms part of the conveyance surface of the sheet conveyance passage at the intersection between the sheet conveyance passage and the branch conveyance passage. The pair of assist rollers conveys a recording medium along the sheet conveyance passage. The conveyance guide is supported to be swingable about a swing axis in a direction in which it retracts from the conveyance surface of the sheet conveyance passage. One of the pair of assist rollers is fixed to a shaft extending parallel to the swing axis and is rotatably supported on the conveyance guide.

### INCORPORATION BY REFERENCE

This application is based on and claims the benefit of priority from Japanese Patent Application No. 2024-179904 filed on October 15, 2024, the contents of which are hereby incorporated by reference.

### BACKGROUND

The present disclosure relates to image forming apparatuses such as copiers, printers, and facsimile machines as well as multifunction peripherals having their functions integrated together.

A known image forming apparatus includes an image forming portion, a sheet feeding portion, a discharge portion, a sheet conveyance passage, a branch conveyance passage, and a conveyance guide. The image forming portion forms an image on a recording medium. The sheet feeding portion feeds the recording medium to the image forming portion. The discharge portion discharges the recording medium having the image formed in the image forming portion. The sheet feeding portion connects together the image forming portion, the sheet feeding portion, and the discharge portion. The branch conveyance passage branches off the sheet conveyance passage. The conveyance guide forms part of the conveyance surface of the sheet conveyance passage at the intersection between the sheet conveyance passage and the branch conveyance passage. The conveyance guide is supported so as to be swingable about a swing axis in a direction in which it retracts from the conveyance surface of the sheet conveyance passage. If a jam (stuck paper) occurs in the sheet conveyance passage, a side cover and the conveyance guide are opened to remove the jam.

Inconveniently, in the known image forming apparatus, the conveyance guide may lose conveying power, causing sheet feeding failure.

An object of the present disclosure is to provide an image forming apparatus that can reduce sheet feeding failure.

### SUMMARY

To achieve the above object, according to one aspect of the present disclosure, an image forming apparatus incudes an image forming portion, a sheet feeding portion, a discharge portion, a sheet conveyance passage, a branch conveyance passage, a conveyance guide, and a pair of assist rollers. The image forming portion forms an image on a recording medium. The sheet feeding portion feeds the recording medium to the image forming portion. The discharge portion discharges the recording medium having the image formed on it in the image forming portion. The sheet conveyance passage connects together the image forming portion, the sheet feeding portion, and the discharge portion. The branch conveyance passage branches off the sheet conveyance passage. The conveyance guide forms part of the conveyance surface of the sheet conveyance passage at the intersection between the sheet conveyance passage and the branch conveyance passage. The pair of assist rollers conveys the recording medium along the sheet conveyance passage. The conveyance guide is supported so as to be swingable about a swing axis in a direction in which the conveyance guide retracts from the conveyance surface of the sheet conveyance passage. One of the pair of assist rollers is fixed to a shaft extending parallel to the swing axis and is rotatably supported on the conveyance guide. This and other objects of the present disclosure, and the specific benefits obtained according to the present disclosure, will become apparent from the description of embodiments which follows.

### BRIEF DESCRIPTION OF THE DRAWINGS

FIG. 1 is a schematic sectional view showing the overall configuration of an image forming apparatus 100 according to one embodiment of the present disclosure.

FIG. 2 is a sectional part view showing, on an enlarged scale, a conveyance guide 65 with its surroundings in the image forming apparatus 100 according to the embodiment.

FIG. 3 is a sectional part view showing, on an enlarged scale, the conveyance guide 65 with its surroundings in the image forming apparatus 100 according to the embodiment.

FIG. 4 is a perspective view showing the conveyance guide 65 in the image forming apparatus 100 according to the embodiment.

### DETAILED DESCRIPTION

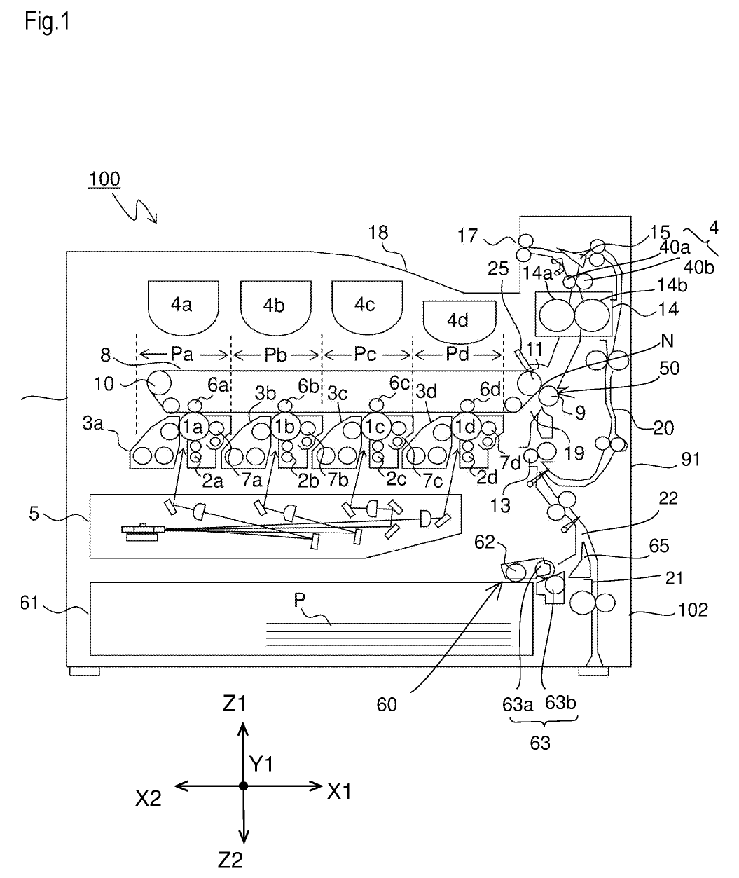

An embodiment of the present disclosure will be described below with reference to the accompanying drawings. FIG. 1 is a sectional view showing the internal structure of an image forming apparatus 100 according to one embodiment of the present disclosure. For convenience of description, with respect to the image forming apparatus 100 in the installed state in which it is usable (as illustrated in FIG. 1), the vertical direction is taken as the top-bottom direction (Z1-Z2). With the near-side face of the image forming apparatus 100 in FIG. 1 taken as the fore face (front face), the front-rear direction (Y1-Y2) is defined. With respect to the fore face of the image forming apparatus 100 in the installed state, the left-right direction (X1-X2) is defined. In the embodiment, the left-right direction (X1-X2) is orthogonal to both the top-bottom direction (Z1-Z2) and the front-rear direction (Y1-Y2). The left-right direction (X1-X2) is taken as the facing direction in which a pair of side faces 102 of the image forming apparatus 100 face each other, and the front-rear direction (Y1-Y2) is taken as the axial direction of a swing axis 65a. The definition of the top-bottom direction here is not meant to limit the actual directions and positional relationships observed during the use of the image forming apparatus 100.

The image forming apparatus 100 includes image forming portions Pa to Pd, a sheet feeding portion 60, a transfer portion 50, a fixing portion 14, a discharge portion 17, a pair of conveyance rollers 40, a sheet conveyance passage 19, and branch conveyance passages 20 and 21.

The image forming apparatus 100 (here a color printer) has, in its body, four image forming portions Pa, Pb, Pc, and Pd disposed in this order from upstream (left side in FIG. 1) along the conveyance direction. The image forming portions Pa to Pd form an image on a transfer sheet (recording medium) P.

More specifically, the image forming portions Pa to Pd are provided for four different colors (yellow, cyan, magenta, and black). The image forming portions Pa to Pd respectively form a yellow, a cyan, a magenta, and a black image sequentially, each through the processes of electrostatic charging, exposure to light, image development, and image transfer.

The image forming portions Pa to Pd form visible images (toner images) of the different colors on photosensitive drums (image carrying members) 1a to 1d. An intermediate transfer belt (intermediate transfer member) 8 that rotates counter-clockwise in FIG. 1 is provided adjacent to the image forming portions Pa to Pd. The toner images formed on the photosensitive drums 1a to 1d are primarily transferred to, so as to be superposed on each other on, the intermediate transfer belt 8, which move while in contact with the photosensitive drums 1a to 1d.

The transfer portion 50 transfers the toner images formed in the image forming portions Pa to Pd to the transfer sheet P (recording medium). The transfer portion 50 includes a driving roller 11 and a secondary transfer roller 9. Specifically, the toner images primarily transferred to the intermediate transfer belt 8 are secondarily transferred by the secondary transfer roller 9 to the transfer sheet P as one example of a recording medium. The transfer sheet P having the toner images secondarily transferred to it then has the toner images fixed to it in the fixing portion 14 and is then discharged out of the body of the image forming apparatus 100.

The sheet feeding portion 60 feeds the transfer sheet P to the image forming portions Pa to Pd. Specifically, the sheet feeding portion 60 includes a sheet cassette 61, a pickup roller 62, and a pair of sheet feed rollers 63. The sheet cassette 61 is disposed in a lower part of the body of the image forming apparatus 100 and stores transfer sheets P to which toner images are to be secondarily transferred. The pickup roller 62 is kept in pressed contact with the top face of the transfer sheet P under a predetermined pressure. Rotating the pickup roller 62 starts the feeding of the transfer sheet P.

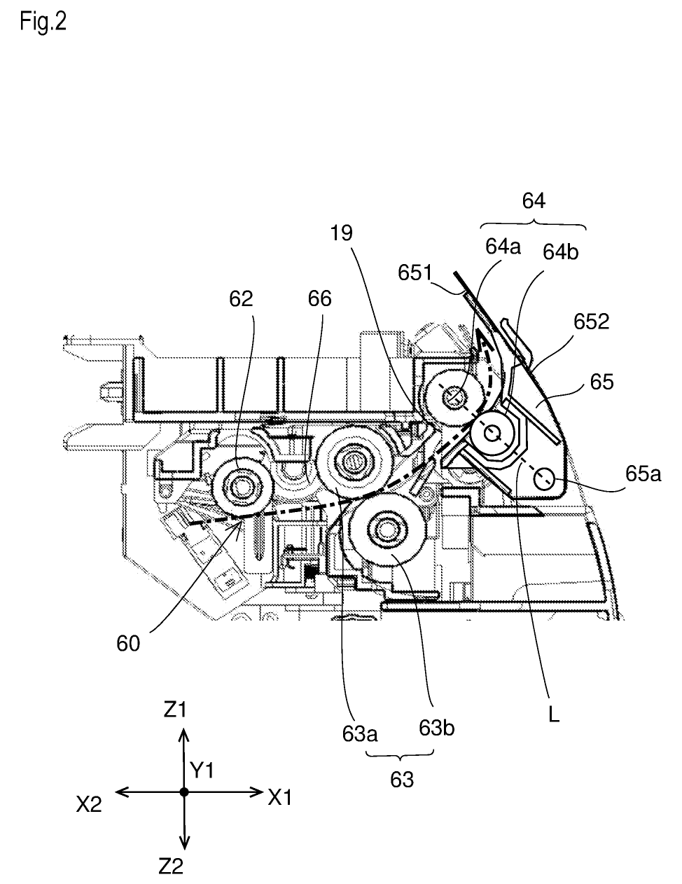

The pair of sheet feed rollers 63 includes a feed roller 63a and a retard roller 63b. The retard roller 63b is kept in pressed contact with the feed roller 63a to rotate by following it. The retard roller 63b incorporates a torque limiter. Between the feed roller 63a and the pickup roller 62, a driving force transmission gear 66 is disposed (see FIG. 2) that transmits the rotation of the feed roller 63a to the pickup roller 62.

Thus, if the pickup roller 62 feeds a plurality of transfer sheets P simultaneously, the feed roller 63a and the retard roller 63b handle them so that only the topmost one sheet will be fed out toward the sheet conveyance passage 19. The pair of sheet feed rollers 63 separates only the topmost one of the plurality of sheets and conveys it toward the sheet conveyance passage 19. The transfer sheet P having passed through the sheet conveyance passage 19 reaches a pair of registration rollers 13 to be conveyed, in time for image formation, to a nip portion between the secondary transfer roller 9 and the driving roller 11 of the intermediate transfer belt 8.

For the intermediate transfer belt 8, a sheet of a dielectric resin is used, which typically is a belt without a seam (seamless belt). Downstream of the secondary transfer roller 9 is disposed a blade-form belt cleaner 25 for removing the toner and the like that are left on the surface of the intermediate transfer belt 8.

Around and below the photosensitive drums 1a to 1d, which are rotatably arranged, there are provided charging device 2a, 2b, 2c, and 2d, an exposure device 5, developing devices 3a, 3b, 3c, and 3d, and cleaning devices 7a, 7b, 7c, and 7d. The charging device 2a, 2b, 3c, and 2d electrostatically charge the photosensitive drums 1a to 1d. The exposure device 5 irradiates the photosensitive drums 1a to 1d with light according to image information. The developing devices 3a, 3b, 3c, and 3d form toner images on the photosensitive drums 1a to 1d. The cleaning devices 7a, 7b, 7c, and 7d remove the developer (toner) and the like that are left on the photosensitive drums 1a to 1d.

When image data is fed in from a host device such as a personal computer, first, the charging devices 2a to 2d electrostatically charge the surfaces of the photosensitive drums 1a to 1d uniformly. Next, the exposure device 5 shines light according to the image data to form on the photosensitive drums 1a to 1d electrostatic latent images according to the image data. The developing devices 3a to 3d are loaded with predetermined amounts of two-component developer containing yellow, cyan, magenta, and black toner, respectively. When as toner images are formed the proportion of the toner in the two-component developer falls below a prescribed value, toner is supplied from toner containers 4a to 4d to the developing devices 3a to 3d.

The toner in the developer is fed by the developing devices 3a to 3d onto the photosensitive drums 1a to 1d and electrostatically attaches to them. This forms toner images according to the electrostatic latent images formed by exposure to the light from the exposure device 5.

Primary transfer rollers 6a to 6d then produce electric fields at a predetermined transfer voltage between the primary transfer rollers 6a to 6d and the photosensitive drums 1a to 1d, so that the yellow, cyan, magenta, and black toner images on the photosensitive drums 1a to 1d are primarily transferred to the intermediate transfer belt 8. These images are formed in a predetermined positional relationship that is previously defined. After that, in preparation for the subsequent formation of new electrostatic latent images, the toner and the like that are left on the surface of the photosensitive drums 1a to 1d after primary transfer are removed by the cleaning devices 7a to 7d.

The intermediate transfer belt 8 is stretched around a driven roller 10, disposed upstream, and a driving roller 11, disposed downstream. When as a belt driving motor (not shown) rotates the driving roller 11 the intermediate transfer belt 8 starts to rotate clockwise, a transfer sheet P is conveyed from the pair of registration rollers 13 to, with predetermined timing, a secondary transfer nip portion N between the driving roller 11 and the secondary transfer roller 9, of which the latter is provided adjacent to the former. The toner images on the intermediate transfer belt 8 are then secondarily transferred to the transfer sheet P passing through the secondary transfer nip portion N.

The transfer sheet P having the toner images secondarily transferred to it is conveyed to the fixing portion 14. The fixing portion 14 includes a fixing belt 14a and a pressing roller 14b. The fixing belt 14a is heated by a heating device (not shown) such as a heater, an induction heating unit, or the like. The pressing roller 14b is kept pressed contact with the fixing belt 14a to form a fixing nip and gives the fixing belt 14a a rotative driving force.

The transfer sheet P conveyed to the fixing portion 14 is heated and pressed by the fixing belt 14a and the pressing roller 14b, so that the toner images are fixed to the surface of the transfer sheet P, forming a predetermined full-color image.

The transfer sheet P having the predetermined full-color image formed on it passes through the pair of conveyance rollers 40 and then has its conveyance direction switched by a conveyance guide member 15 disposed in a branch portion of the sheet conveyance passage 19 to be discharged as it is (or after being conveyed to the branch conveyance passage 20 to have images formed on both sides) to a discharge tray 18 by a pair of discharge rollers (discharge portion) 17.

Specifically, the pair of discharge rollers (discharge portion) 17 discharges the transfer sheet (recording medium) P having toner images formed on it in the image forming portions Pa to Pd. The pair of conveyance rollers 40 conveys the transfer sheet (recording medium) P from the fixing portion 14 to the pair of discharge rollers (discharge portion) 17. The pair of conveyance rollers 40 includes a driving conveyance roller 40a and a driven conveyance roller 40b. The driving conveyance roller 40a is driven by a motor (not shown), and the driven conveyance roller 40b rotates by following the driving conveyance roller 40a.

The sheet conveyance passage 19 connects together the sheet feeding portion 60, the transfer portion 50, the fixing portion 14, and the discharge portion 17. The branch conveyance passage 20 branches off the sheet conveyance passage 19 downstream of the pair of conveyance rollers 40 and joins the sheet conveyance passage 19 upstream of the pair of registration rollers 13. The branch conveyance passage 20 extends along the top-bottom direction (Z1-Z2) along a side face 102 of the image forming apparatus 100 and is curved substantially in a C-shape. The branch conveyance passage 21 branches off the sheet conveyance passage 19 upstream of the intersection between the branch conveyance passage 20 and the sheet conveyance passage 19, and extends along the top-bottom direction (Z1-Z2) along the side face 102 of the image forming apparatus 100.

A side cover 91 forms the side face 102 of the image forming apparatus 100 and is, for example, pivotably supported on a cover pivot (not shown) provided in a lower part of the body of the image forming apparatus 100.

The inner side face of the side cover 91 forms the outer side face of the branch conveyance passages 20 and 21. Opening the side cover 91 exposes the branch conveyance passages 20 and 21.

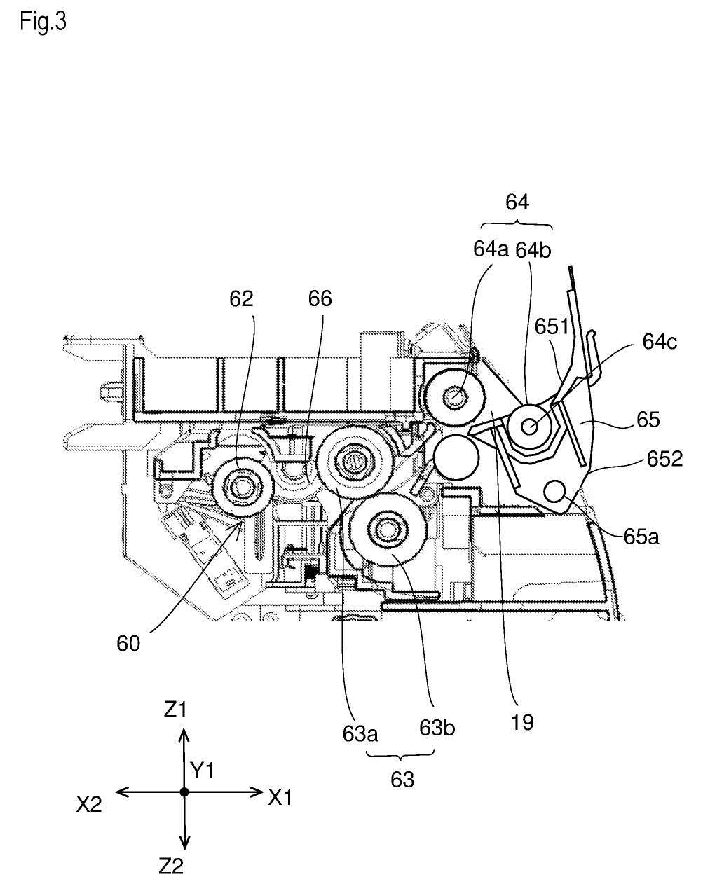

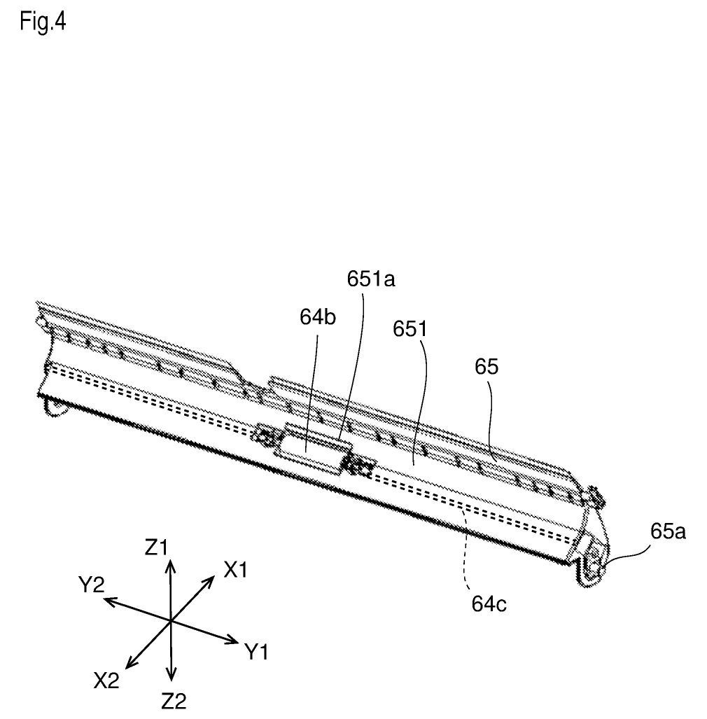

FIGS. 2 and 3 are enlarged part views around a conveyance guide 65, a dash-and-dot line in FIG. 2 indicating the conveyance direction of the transfer sheet P. In FIG. 2, the conveyance guide 65 is located in a position in which it forms part of the conveyance surface of the sheet conveyance passage 19 and, in FIG. 3, the conveyance guide 65 is in a state retracted from the conveyance surface of the sheet conveyance passage 19. FIG. 4 is a perspective view of the conveyance guide 65.

The image forming apparatus 100 further includes the conveyance guide 65 and a pair of assist rollers 64. The conveyance guide 65 is, for example, a molding of resin, and forms part of the conveyance surface of the sheet conveyance passage 19 and of the branch conveyance passage 21 at the intersection 22 between the sheet conveyance passage 19 and the branch conveyance passage 20. The conveyance guide 65 is supported so as to be swingable about a swing axis 65a in a direction retracting from the conveyance surface of the sheet conveyance passage 19.

More specifically, the conveyance guide 65 is configured such that, in a section orthogonal to the axial direction of the swing axis 65a, the left X1 side face 651 of the conveyance guide 65 forms part of the conveyance surface of the sheet conveyance passage 19 and the right X2 side face 652 of the conveyance guide 65 forms part of the conveyance surface of the branch conveyance passage 21. Moreover, the swing axis 65a is configured to protrude from the opposite end faces of the conveyance guide 65 along the axial direction (Y1-Y2) of the conveyance guide 65, and the swing axis 65a is swingably supported on a bearing portion (not shown) in the apparatus body.

The pair of assist rollers 64 conveys a transfer sheet P (recording medium) along the sheet conveyance passage 19. In the embodiment, the pair of assist rollers 64 includes a driving assist roller 64a (the other of the pair of assist rollers 64) and a driven assist roller 64b (one of the pair of assist rollers 64). The driving assist roller 64a is coupled to the apparatus body.

On the other hand, the driven assist roller 64b (one of the pair of assist rollers 64) is fixed to a shaft 64c extending parallel to the swing axis 65a and is rotatably supported on the conveyance guide 65. Arranging the pair of assist rollers 64 on the conveyance guide 65 improves the conveying power for the transfer sheet P at the conveyance guide 65.

Pressing the driven assist roller 64b (one of the pair of assist rollers 64) against the driving assist roller 64a (the other of the pair of assist rollers 64) with a predetermined pressure improves the conveying power for the transfer sheet P. The shaft 64c is, for example, a cylindrical member made of metal and the conveyance guide 65 is reinforced by the shaft 64c to have increased mechanical strength. This makes the conveyance guide 65 less likely to warp to bulge in a direction away from the driving assist roller 64a (the other of the pair of assist rollers 64). This keeps the pressing force in the pair of assist rollers 64 constant and prevents a drop in the conveying power for the transfer sheet P.

The side face 651 of the conveyance guide 65 has a recessed portion 651a in a middle part of it along the axial direction (Y1-Y2) and in this recessed portion 651a the driven assist roller 64b is disposed. That is, the driven assist roller 64b (one of the pair of assist rollers 64) is located in a middle part of the conveyance guide 65 along the axial direction (Y1-Y2) of the swing axis 65a. This stabilizes the conveying power for the transfer sheet P at the conveyance guide 65 and prevents jams.

The shaft 64c is disposed between the side faces 651 and 652 of the conveyance guide 65 and extends over the entire width of the conveyance guide 65 along the axial direction (Y1-Y2) of the swing axis 65a. Thus, the shaft 64c gives the conveyance guide 65 increased mechanical strength, which helps prevent deformation more effectively.

The shaft 64c is located above Z1 the swing axis 65a, and the swing axis 65a and the center of gravity of the conveyance guide 65 are set so as to produce a moment that makes the conveyance guide 65 swing under its own weight in a direction in which it retracts from the conveyance surface of the sheet conveyance passage 19.

When the side cover 91 is pivoted in the opening direction with respect to the image forming apparatus 100, the branch conveyance passage 21 is exposed over a large area. From this state, swinging the conveyance guide 65 in the direction retracting away from the conveyance surface of the sheet conveyance passage 19 opens up part of the sheet conveyance passage 19.

The swing axis 65a and the center of gravity of the conveyance guide 65 are set so as to produce a moment that makes the conveyance guide 65 swing under its own weight in a direction in which it retracts from the conveyance surface of the sheet conveyance passage 19, and thus the conveyance guide 65 rotates easily. Hence, if a jam (stuck paper) occurs near the intersection 22 in the sheet conveyance passage 19, the side cover 91 and the conveyance guide 65 can be opened so that the jam can be removed efficiently.

In a section orthogonal to the swing axis 65a, the rotary shafts of the pair of assist rollers 64 and the swing axis 65a are aligned on a straight line (see FIG. 2) and thus, when the side cover 91 is opened, the conveyance guide 65 is easily acted on a force in the direction retracting from the conveyance surface of the sheet conveyance passage 19 under the repulsion force between the pair of assist rollers 64. This makes easier for the conveyance guide 65 to rotate. Thus, with the conveyance guide 65 open, the jam can be removed more efficiently.

On the other hand, pivoting the side cover 91 in the closing direction causes the conveyance guide 65 to be pressed by the side cover 91 to rotate in the closing direction. Thus, the driven assist roller 64b (one of the pair of assist rollers 64) is pressed against the driving assist roller 64a (the other of the pair of assist rollers 64). In this way, by bringing the side cover 91 back to the closed state it is possible to bring the conveyance guide 65 back to the closes state simultaneously.

The embodiment described above is in no way meant to limit the present disclosure, which can thus be implemented with any modifications made without departure from the spirit of the present disclosure. For example, while the embodiment described above takes up the conveyance guide 65, a similar effect can be obtained, instead, by disposing the pair of assist rollers on the conveyance guide member 15 that forms part of the conveyance surface of the sheet conveyance passage 19 at the intersection between the sheet conveyance passage 19 and the branch conveyance passage 20. Moreover, fixing the driven assist roller to a shaft and rotatably supporting it on the conveyance guide member 15 helps reinforce and increase the mechanical strength of the conveyance guide member 15. This provides an effect similar to that mentioned above for the conveyance guide 65.

The present disclosure finds applications not only in color copiers but also in any other image forming apparatuses that employ vertical conveyance, such as analog copiers, digital multifunction peripherals, monochrome and color printers, and facsimile machines.

What is claimed is:

1. An image forming apparatus comprising:
an image forming portion that forms an image on a recording medium;
a sheet feeding portion that feeds the recording medium to the image forming portion;
a discharge portion that discharges the recording medium having the image formed thereon in the image forming portion;
a sheet conveyance passage that connects together the image forming portion, the sheet feeding portion, and the discharge portion;
a branch conveyance passage that branches off the sheet conveyance passage;
a conveyance guide that forms part of a conveyance surface of the sheet conveyance passage at an intersection between the sheet conveyance passage and the branch conveyance passage; and
a pair of assist rollers that conveys the recording medium along the sheet conveyance passage,
wherein
the conveyance guide is supported so as to be swingable about a swing axis in a direction in which the conveyance guide retracts from the conveyance surface of the sheet conveyance passage, and
one of the pair of assist rollers is fixed to a shaft extending parallel to the swing axis and is rotatably supported on the conveyance guide.

2. The image forming apparatus according to claim 1, wherein
the shaft extends over an entire width of the conveyance guide along an axial direction of the swing axis.

3. The image forming apparatus according to claim 1, wherein
one of the pair of assist rollers is located in a middle part of the conveyance guide along an axial direction of the swing axis.

4. The image forming apparatus according to claim 1, wherein
the swing axis and a center of gravity of the conveyance guide are set so as to produce a moment that makes the conveyance guide swing under an own weight thereof in a direction in which the conveyance guide retracts from the conveyance surface of the sheet conveyance passage.

5. The image forming apparatus according to claim 1, wherein
in a section orthogonal to the swing axis, rotary shafts of the pair of assist rollers and the swing axis are aligned on a straight line.
